(19) United States
(12) Patent Application Publication
(10) Pub. No.: US 2018/0247276 A1
(43) Pub. Date: Aug. 30, 2018

(54) WORKFLOW MANAGEMENT WITH LOCATION TEMPORAL AND BIOMETRIC INFORMATION

(71) Applicant: Microsoft Technology Licensing, LLC, Redmond, WA (US)

(72) Inventors: Leela S. Tamma, San Ramon, CA (US); Matthew J. Burdick, Sunnyvale, CA (US)

(73) Assignee: Microsoft Technology Licensing, LLC, Redmond, WA (US)

(21) Appl. No.: 15/444,360

(22) Filed: Feb. 28, 2017

(51) Int. Cl. G06Q 10/10; G06Q 10/06; G06K 7/14; H04W 4/02

(52) U.S. Cl. CPC G06Q 10/1097; G06Q 10/103; H04W 4/021; G06K 7/1417; G06Q 10/0633

(57) ABSTRACT

Variety of approaches to provide a workflow management with location, temporal, and biometric information are described. A scheduling service initiates operations to provide the workflow management upon receiving a start task signal from a client device of an employee at a start time-period associated with a task. The start task signal includes a biometric identifier associated with the employee, a location of the client device, and a task identifier of the task. The task is identified within a schedule using the task identifier. The schedule is composed by a manager of the employee. The biometric identifier is verified as matching the employee. The location of the client device is confirmed as within a geo-fenced area designated to the task. A status of the task is recorded as started within the schedule.

### BACKGROUND

Information exchange have changed processes associated with work and personal environments. Automation and improvements in processes have expanded scope of capabilities offered for personal and business consumption. With the development of faster and smaller electronics, execution of mass processes at cloud systems have become feasible. Indeed, applications provided by data centers, data warehouses, data workstations have become common features in modern personal and work environments. Such systems execute a wide variety of applications ranging from enterprise resource management applications to scheduling tools.

Increasingly, cloud scheduling providers are utilized for monitoring and tracking schedule of user(s), where the cloud scheduling providers have client interface(s) that automatically track performance of activity(s) associated with the user(s). However, there are currently significant gaps when scheduling and tracking user(s) performance of activity(s). Personnel resources are unnecessarily consumed to track and schedule activity(s) of the user(s). Lack of relevant activity scheduling and tracking schemes lead to poor management of personnel resources when generating and maintaining schedule(s) for user(s).

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a workflow management based on location, temporal, and biometric information. A scheduling service, according to embodiments, may initiate operations to provide the workflow management upon receiving a start task signal from a client device of an employee at a start time-period associated with a task. The start signal may include a biometric identifier associated with the employee, a location of the client device, and a task identifier of the task. Next, the task may be identified within a schedule using the task identifier. The schedule may be composed by a manager of the employee. The biometric identifier may be verified as matching the employee. The location of the client device may be confirmed as within a geo-fenced area designated to the task. A status of the task may be recorded as started within the schedule.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating examples of providing a workflow management with location, temporal, and biometric information, according to embodiments;

FIG. 2 is a display diagram illustrating example components of a scheduling service that provides a workflow management with location, temporal, and biometric information, according to embodiments;

FIG. 3 is a display diagram illustrating components of a scheme to provide a workflow management with location, temporal, and biometric information, according to embodiments;

FIG. 4 is a display diagram illustrating dynamic workflow management with location, temporal, and biometric information, according to embodiments;

FIG. 5 is a simplified networked environment, where a system according to embodiments may be implemented;

FIG. 6 is a block diagram of an example computing device, which may be used to provide a workflow management with location, temporal, and biometric information, according to embodiments; and

FIG. 7 is a logic flow diagram illustrating a process for providing a workflow management with location, temporal, and biometric information, according to embodiments.

### DETAILED DESCRIPTION

As briefly described above, a scheduling service may provide a workflow management based on location, temporal, and biometric information. In an example scenario, the scheduling service may receive a start task signal from a client device of an employee at a start time-period associated with a task. The client device may include a mobile computing device such as a smartphone. The client device may execute a client interface of the scheduling service that captures task and user information to monitor and authenticate task related activities. An example of the captured task and user information, the start signal, may include a biometric identifier associated with the employee, a location of the client device, and a task identifier of the task. The biometric identifier may include a unique identifier associated with the employee such as a thumbprint, a facial pattern, an eye pattern, a voice sample, among others. The location may include coordinate information captured by the client device such as a GPS location and/or triangulated coordinates, among others. The task identifier may include a quick response (QR) code. The task identifier may be situated at a site associated with the task.

Next, the scheduling service may identify the task within a schedule using the task identifier. The task may include one or more activities assigned to the employee that span a time-period. The task may include a start time-period during which the employee may specify the task as started and an end time-period during which the employee may specify the task as completed (or incomplete). The schedule may be composed by a manager of the employee. The schedule may be composed by the manager based on a machine learned model where roles such as an employee/manager are identified from an external and/or an internal human capital management system. The scheduling service may verify the biometric identifier as matching the employee. The biometric identifier may be compared to a biometric information of the employee from a profile of the employee. The location of the client device may also be confirmed as within a geo-fenced area designated to the task. The geo-fenced area may be defined by the manager as a property of the task or may be automatically inferred based on attribute(s) of the task. Upon verification of information within the start task signal, a status of the task may be recorded as started within the schedule.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing a workflow management with location, temporal, and biometric information. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

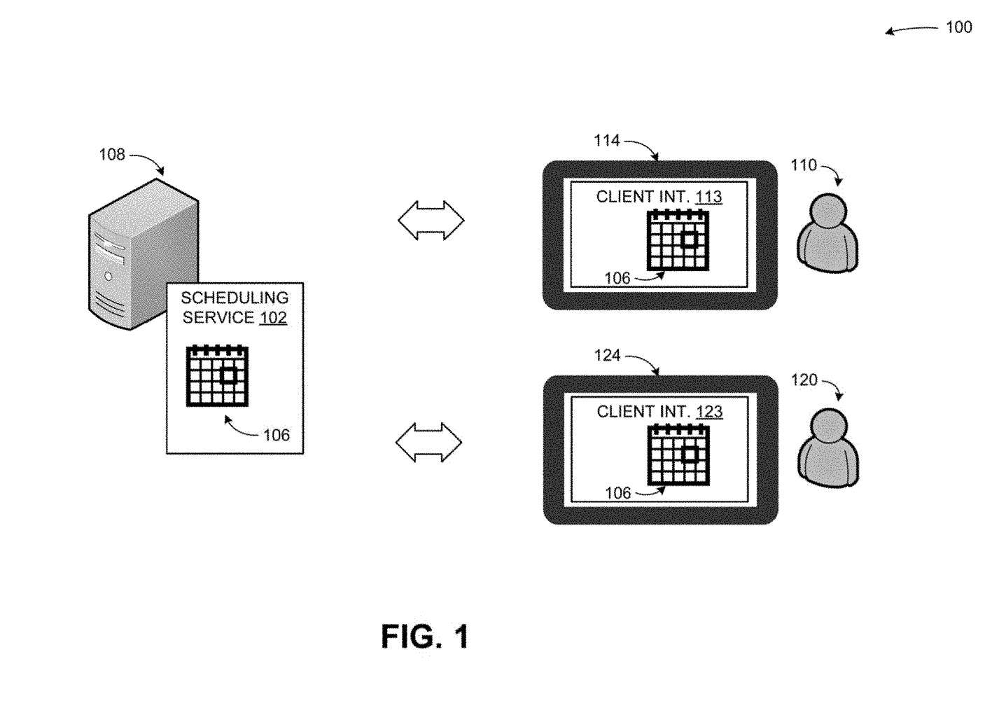

FIG. 1 is a conceptual diagram illustrating examples of providing a workflow management with location, temporal, and biometric information, according to embodiments.

In a diagram 100, a server 108 may execute a scheduling service 102. The server 108 may include a physical server providing service(s) and/or application(s) to client devices. A service may include an application performing operations in relation to a client application and/or a subscriber, among others. The server 108 may include and/or is part of a workstation, a data warehouse, a data center, and/or a cloud based distributed computing source, among others.

The server 108 may execute the scheduling service 102. The scheduling service 102 may initiate operations to provide a workflow management upon receiving a start task signal from a client device 114 of an employee 110 at a start time-period associated with a task. The employee 110 may include a person (or a computing device, such as a robot) who works on the task. An example of the client device 114 may include a mobile computing device such as a smartphone. The client device 114 may execute a client interface 113 that captures task and user information to monitor and authenticate task related activities. An example of the captured task and user information, the start signal, may include a biometric identifier associated with the employee 110, a location of the client device 114, and a task identifier of the task. The biometric identifier may include a unique identifier associated with the employee 110 such as a thumbprint, a facial pattern, an eye pattern, a voice sample, among others. The location may include coordinate information captured by the client device 114 such as a GPS coordinates and/or triangulated coordinates, among others. The task identifier may include a quick response (QR) code. The task identifier may be situated at a location associated with the task.

Next, the scheduling service 102 may identify the task within a schedule 106 using the task identifier. The task may include one or more activities assigned to the employee 110 that span a time-period. An example of the task may include a shift. The task may include a start time-period during which the employee 110 may specify the task as started and an end time-period during which the employee may specify the task as completed (or incomplete). The schedule 106 may be composed by a manager 120 of the employee 110. The manager 120 may interact with the schedule 106 through a client interface 123 (of the scheduling service 102) provided by a client device 124.

Furthermore, the scheduling service 102 may verify the biometric identifier (scanned by the client device 114) as matching, the employee 110. The biometric identifier may be compared to a biometric information of the employee 110 retrieved from a profile of the employee 110. The location of the client device 114 may also be confirmed as within a geo-fenced area designated to the task. The geo-fenced area may be defined by the manager 120 as a property of the task or may be automatically inferred based on attribute(s) of the task. Upon verification of information within the start task signal, a status of the task may be recorded as started within the schedule 106.

The server 108 may communicate with the client device 114 and/or the client device 124 through a network. The network may provide wired or wireless communications between network nodes such as the client device 114, the client device 124 and/or the server 108, among others. Previous example(s) to provide a workflow management with location, temporal, and biometric information are not provided in a limiting sense. Alternatively, the scheduling service 102 may provide the schedule 106 and the task assigned to the employee 110 as a desktop application, a workstation application, and/or a server application, among others. The client interfaces (113 and/or 123) may also include a client application interacting with the scheduling service 102.

The employee 110 (or the manager 120) may interact with the client interface 113 (or the client interface 123), respectively, with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the server 108, the scheduling service 102, embodiments are not limited to these components or system configurations and can be implemented with other system configuration employing fewer or additional components.

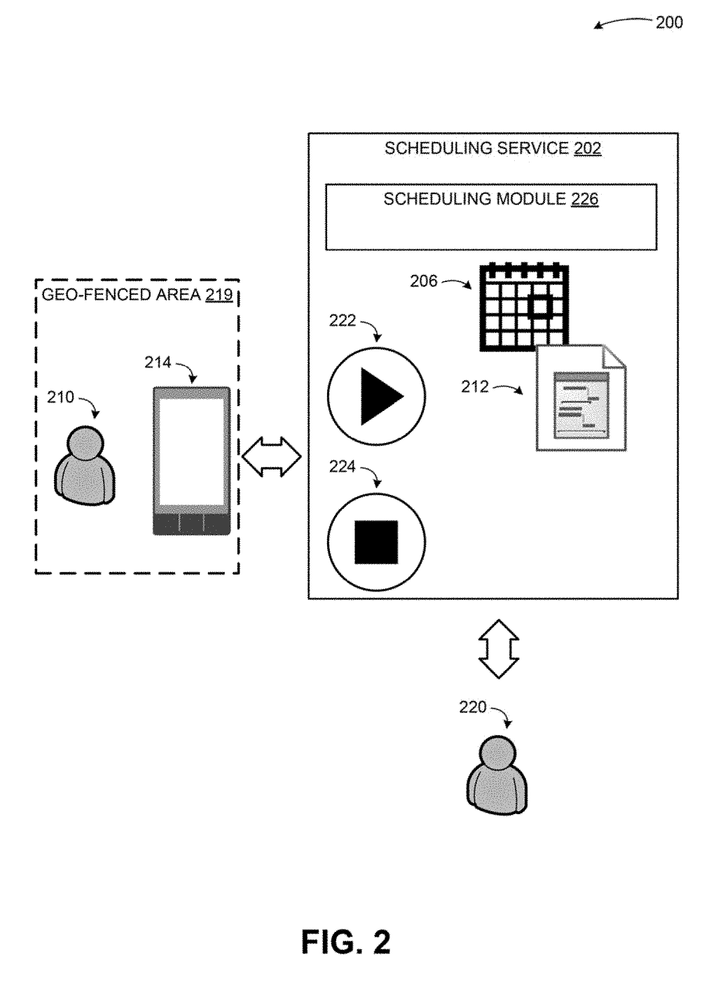

FIG. 2 is a display diagram illustrating example components of a scheduling service that provides a workflow management with location, temporal, and biometric information, according to embodiments.

As illustrated in diagram 200, a scheduling module 226 of a scheduling service 202 may monitor and manage a work flow of an employee 210 (or other entity). The work flow of an employee may include task(s) that may be assigned to the employee 210 within a schedule 206. An example of a task may include a shift. For example, a task 212 that is assigned to the employee 210 may be monitored by a client interface of the scheduling service 202 (executed on the client device 214) at a work location. The work location may be encompassed by a geo-fenced area 219 to detect when the employee 210 is within the geo-fenced area 219. The geo-fenced area 219 may include a virtual zone (defined by co-ordinates or as a partition of a structure such as a building) within which the client interface or module may trigger events. Example of events may include entry into the geo-fenced area 219, stay within the geo-fenced area 219 (which may include continued activity monitoring such as movement, among others), and/or exit out of the two-fenced area 219, among others.

In an example scenario, the scheduling module 226 may receive a start task signal 222 from the client interface at a start-time period associated with a task 212. The employee 210 may carry the client device 214 on his/her person while the scheduling module 226 monitors activities related to the task 212. The client interface may transmit the start task signal 222 upon detecting an entry into the geo-fenced area 219 (such as a work-site). The start task signal may include a biometric identifier associated with the employee 210, a location of the client device 214, and a task identifier of the task 212. The biometric identifier (such as a thumbprint) may be scanned by the client device 214 upon an action by the employee to do as such. The biometric identifier may be scanned to authenticate the employee 210 at the designated work-site at the start time-period of the task 212. The task identifier may include a quick response (QR) code or an radio frequency identification (RFID) signal from an RFID chip associated with the task site such as the geo-fenced area 219.

For example, the QR code (he RFID chip) may be affixed to a structure associated with the task 212 within the geo-fenced area 219. The employee 210 may scan the QR code (or interact with the RFID chip) through the client interface at a start time-period of the task to generate the start task signal 222. Further more the client interface may provide the location of the client device 214 to the scheduling service 202 within the start task signal 222.

The scheduling module 226 may identify the task 212 within the schedule 206 by searching the schedule 206 with the task identifier provided in the start task signal 222. The biometric identifier provided in the start task signal 222 may also be verified as matching the employee. The biometric identifier may be verified by comparing the biometric identifier to biometric information of the employee retrieved from a profile of the employee 210. The profile of the employee 210 may be stored within a personnel data source.

The location of the client device (provided within the start task signal 222) may also be confirmed as within the geo-fenced area 219 designated to the task 212. If the biometric identifier and the location of the client device 214 are verified and confirmed to match parameters of the task 212 at the start time-period of the task 212 then a status of the task 212 may be recorded as started within the schedule 206. A stakeholder (such as a manager 220) may monitor the task 212 and the status of the task 212 through the schedule 206.

Furthermore, the scheduling module 226 may request and/or receive additional task related signal(s) while the task 212 is ongoing. For example, the client interface may transmit an end task signal 224 that includes a rescanned task identifier, a rescanned biometric identifier and a location at an end time-period of the task 212. Upon verification of the rescanned biometric identifier, the rescanned task identifier, and the location at the end time-period of the task 212, the scheduling module 226 may record the status of the task 212 as completed. In an alternative scenario, if the information provided in the start task signal 222 or the end task signal 224 is not verified, the status of the task 212 may be recorded as unverified (start or end) or the task 212 may be recorded as not started and/or incomplete. Furthermore, if the information provided in the start task signal 222 or the end task signal 224 is not verified, the task 212 may be transferred to a future time-period (such as a future shift, and/or a following shift, among others) or a person starting a new task following the task 222 (such as an employee stating a following shift).

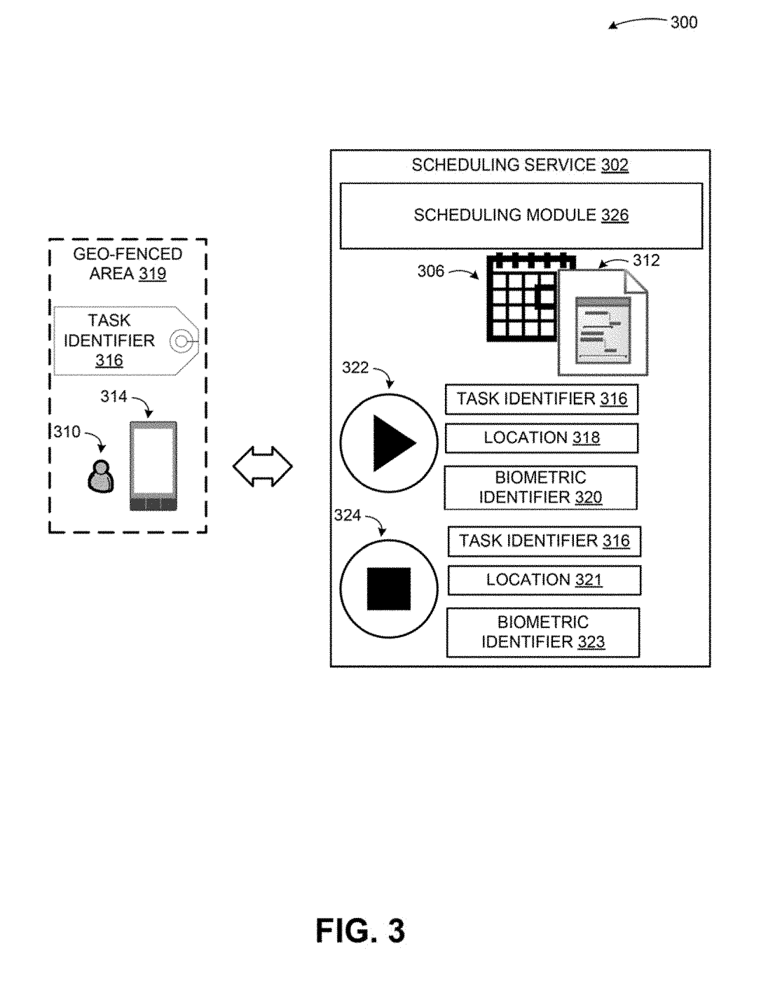

FIG. 3 is a display diagram illustrating components of a scheme to provide a workflow management with location, temporal, and biometric information, according to embodiments.

As shown in a diagram 300, a scheduling module 311 of a scheduling service 302 may receive activity information associated with a task 312 through a start task signal 322 or an end task signal 324. In an example scenario, an employee 310 may arrive at a work site that may be defined by a geo-fenced area 319. A client device 314 carried by the employee may execute a client interface of a scheduling module 326. The client interface may detect the location of the client device 314 as within the geo-fenced area 319 and initiate an event such as prompting the employee 310 to begin an activity associated with a task. For example, the client interface of the scheduling module 326 may provide a scan interface to prompt the employee 310 to scan a task identifier to begin a task (for example start a shift). The employee may scan a task identifier 316 situated within the geo-fenced area 319. The client interface of the scheduling module 326 may also prompt the employee to authenticate a presence of the employee 310 at the geo-fenced area 319 by providing a biometric identifier 320.

Upon scanning the biometric identifier 320, the client interface may transmit the start task signal 322 to the scheduling module 326 that includes the task identifier 316, a location 318 of the client device 314, and the biometric identifier 320 of the employee 310. The scheduling module may locate the task 312 within a schedule 306 (provided by a manager) by searching for the task 312 with the task identifier 316. Next, the biometric identifier 320 may be matched to biometric information of the employee 310 retrieved from a profile of the employee 310. The profile of the employee 310 may be provided by a personnel data source.

Furthermore, the client device 314 may be validated by comparing information associated with the scanner (the client device 314) of the biometric identifier 320 or the task identifier 316 to information about the client device 314 stored in the profile of the employee 310. For example, the client device 314 may be assigned to the employee 310 and registered in the profile of the employee 310. Information about the scanner (the client device 314) may be transmitted with the start task signal 322 (or the end task signal 324) which may be compared to the information of the client device 314 stored within the profile of the employee 310 If the information of the client device 314 sent with the start task signal 322 (or the end task signal 324) matches the information of the client device 314 stored in the profile, the client device 314 may be verified.

Furthermore, a scan time of the biometric identifier 320 may be matched to a start time-period of the task 312 to verify the employee 310 as on time. Similarly, a scan time of the task identifier 316 may be matched to the start time-period of the task 312 to verify the employee 310 as on time. The start time-period of the task 312 may be a property of the task 312. The start time-period of the task 312 may be defined by the manager of the employee 310. Alternatively, the start time-period of the task 312 may be auto-generated based on parameters of the task such as a duration of the task and flexibility at a beginning of the task 312 to start and complete the task 312 on time without delay.

Similarly, a client interface of the scheduling service 302 (executing on the client device 314) may generate (or may be prompted to generate by the scheduling service 302) an end task signal 324 when the user proceeds with activities to change a status of the task 312 to completed (or incomplete) at an end time-period of the task 312. For example, the client interface may prompt the employee 310 to rescan the task identifier 316. Alternatively, the client interface may allow the employee 310 to continue with end of task activities associated with the task 312 without having to rescan the task identifier 316. For example, the employee may be prompted to select the task 312 to initiate the end of the task activities.

A location 321 of the client: device 314 may be captured during the task end-period. If the location 321 at the task end-period is verified as within the geo-fenced area 319, the scheduling module 326 may change the status of the task 312 to completed. Alternatively, if the location 321 of the client device 314 may be detected as outside the geo-fenced area 319 or as not available, the status of the task 312 may be designated as incomplete.

Furthermore, a biometric identifier 323 may be scanned by the client interface at the task end-period and transmitted to the scheduling module 326 within the end task signal 324. The scheduling module 326 may analyze the end task signal 324 to verify the biometric identifier 323 as matching the employee 310. If the biometric identifier 323 may be identified as matching the employee 310, the status of the task 312 may be recorded as completed. If the biometric identifier 323 may not be verified, the status may be recorded as incomplete. If the biometric identifier 323 is not matched to the employee 310, the manager of the employee 310 may also be notified of the mismatch.

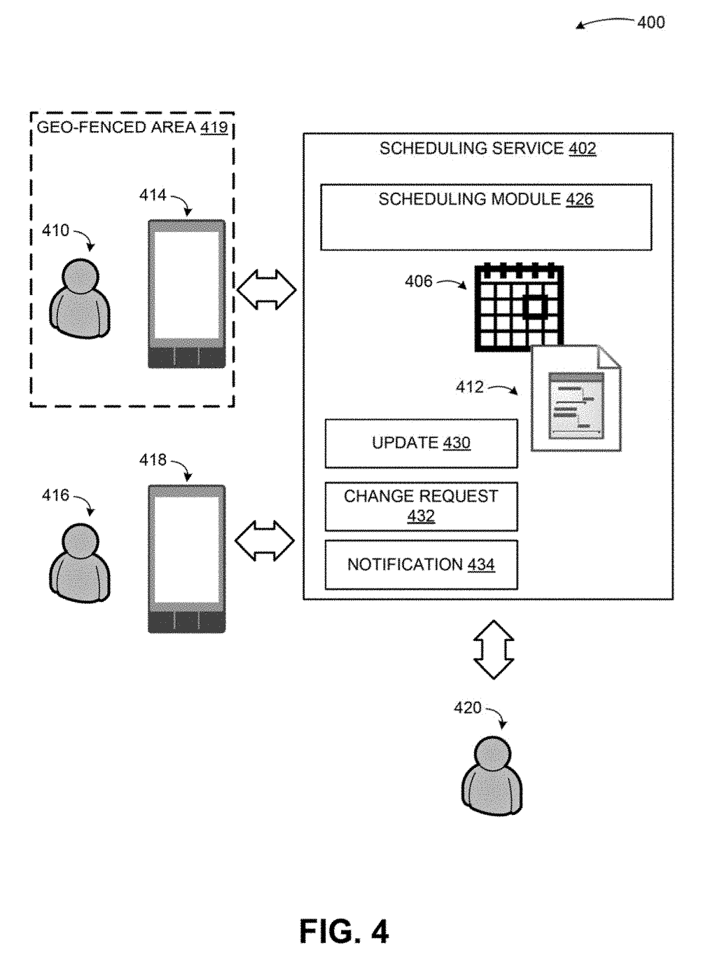

FIG. 4 is a display diagram illustrating dynamic workflow management with location, temporal, and biometric information, according to embodiments.

As shown in a diagram 400, a scheduling module 426 of a scheduling service 402 may receive a schedule 406 from a manager 420. Alternatively, the manager 420 may generate the schedule 406 using the scheduling service 402. The schedule 406 may include a task 412 which may describe an activity of an employee 410 such as a shift. The schedule 406 may be transmitted to a client interface executed by a client device 414 of an employee 410 along with a request for a confirmation of the schedule 406. The schedule 406 may also be transmitted to other employee(s) such as an employee 416 through a client interface of the scheduling service 402 (executed on the client device 418). The schedule 406 may include a task assigned to the employee 416 for which the schedule service 402 may request a confirmation.

In an example scenario, the schedule 406 may be updated or changed dynamically by stakeholder(s) such as the manager 420. The scheduling module 426 may automate notification and confirmation processes involving the employee 410 and the employee 416. For example, the manager 420 may transmit an update 430 to the schedule that may change a parameter of the task 412. The scheduling module 426 may modify the task 412 to accommodate the update 430. Furthermore, the scheduling module 426 may transmit a confirmation request to the client device 414 to prompt a client interface of the scheduling service 402 (executed by the client device 414) to present the update 430 to the employee 410. The employee 410 may be requested to confirm the update 430 to the task 412.

The client interface of the scheduling service 402 may capture a biometric identifier of the employee 410 to verify an entity confirming the update 430 as the employee 410. The biometric identifier may be matched to biometric information of the employee 410 retrieved from a profile of the employee hosted by a personnel data source. Upon verifying the biometric identifier, a status of the task 412 may be changed to updated and confirmed.

Furthermore, an employee 410 may transmit a change request 432 to modify the task 412. For example, the change request 432 may ask for re-assignment of the task 412 to the employee 416. The scheduling module 426 may address the change request 432 manually or automatically. In a manual scenario, the scheduling module 426 may generate a notification 434 that includes the change request 432, the notification may be sent to the manager 420 (and the employee 416) to prompt for a confirmation or a rejection. If the manager 420 (and the employee 416) confirms the change request 432, the scheduling module 426 may re-assign the task 412 to the employee 416. Alternatively, the scheduling module 426 may automatically re-assign the task 412 to the employee 416 if the scheduling module 426 may infer that the employee 416 may have an availability and a skill (necessary) to complete the task 412. The notification 434 may be generated and transmitted to the manager 420 to inform the manager 420 of the automated re-assignment of the task 412.

In an example scenario, the scheduling module 426 may receive a task related signal from the client device 414 that describes a location of the client device 414 as within a geo-fenced area 419. If the scheduling module 426 may infer the employee as engaged within the task 412 while within the geo-fenced area 419 (designated to the task 412), the scheduling module 426 may instruct the client device 414 based on a work rule to suppress notification(s) received during a time-period of the task 412 (to prevent distraction, noise pollution, among other reasons within the geo-fenced area 419). The work rule may be defined by the manager 420 or by an organizational policy impacting the employee 410. Alternatively, the scheduling module 426 may instruct the client device 414 to allow receiving and delivery of notification(s) during the time-period of the task 412.

The scheduling service 402 may also generate and transmit a reminder to the employee 410 in relation to the task 412. For example, upon detecting an end time-period of the task 412, the scheduling module 426 may transmit a reminder to complete an end-task activity which may include a transition action (such as transfer work to new shift employee), a clock-out action (such as initiate end of the task 412), and a report action (such as generate and transmit a report about the task 412 to the manager 420).

The scheduling service 402 may further assure compliance with law(s) and regulation(s). For example, upon receiving the change request 432, the scheduling module 426 may verify the change request 432 does not place the employee 410 or the employee 416 above allowable number of workable hours during a time-period as defined by regulation(s) and/or law(s). If the scheduling module 426 detects noncompliance with regulation(s) and/or law(s) affecting performance of the task 412 then the scheduling module 426 may reject the change request 432 automatically. However, if the change request 432 is detected as in compliance with laws(s) and/or regulation(s) then the change request 432 may be approved or further processed for additional acceptance criteria.

As discussed above, the scheduling service may be employed to perform operations to automate a workflow management with location, temporal, and biometric information. An increased performance and efficiency improvement with the scheduling service 102 may occur as a result of tracking and managing schedule related activity through a client interface executed on a client device in a possession of a performer of the activity. Additionally, automating approval and confirmation of update(s) and change(s) to the schedule, by the scheduling service 102, may reduce processor load, increase processing speed, conserve memory, and reduce network bandwidth usage.

Embodiments, as described herein, address a need that arises from a lack of efficiency to provide a workflow management with location, temporal, and biometric information. The actions/operations described herein are not a mere use of a computer, but address results that are a direct consequence of software used as a service offered to large numbers of users and applications.

The example scenarios and schemas in FIG. 1 through 4 are shown with specific components, data types, and configurations. Embodiments are not limited to systems according to these example configurations. Providing a workflow management with location, temporal, and biometric information may be implemented in configurations employing fewer or additional components in applications and user interfaces. Furthermore, the example schema and components shown in FIG. 1 through 4 and their subcomponents may be implemented in a similar manner with other values using the principles described herein.

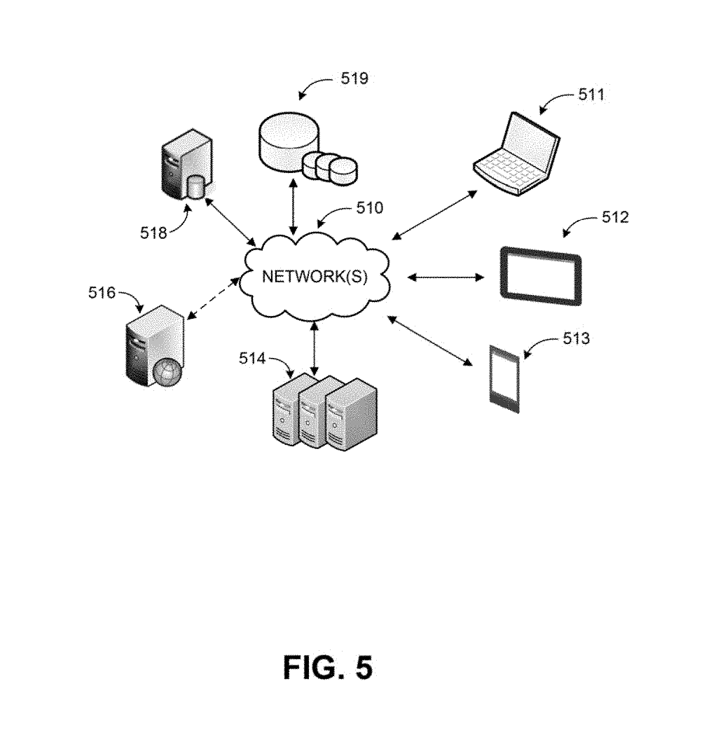

FIG. 5 is an example networked environment, where embodiments may be implemented. A scheduling service configured to provide a workflow management may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A scheduling service may receive a start task signal from a client device of an employee at a start time-period associated with a task. The start signal may include a biometric identifier associated with the employee, a location of the client device, and a task identifier of the task. Next, the task may be identified within a schedule using the task identifier. The schedule may be composed by a manager of the employee. The biometric identifier may be verified as matching the employee. The location of the client device may be confirmed as within a geo-fenced area designated to the task. A status of the task may be recorded as started within the schedule. The scheduling service may store data associated with the schedule in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide a workflow management with location, temporal, and biometric information. Furthermore, the networked environments discussed in FIG. 5 are for illustration purposes only. Embodiments are not limited to the example applications, modules, or processes.

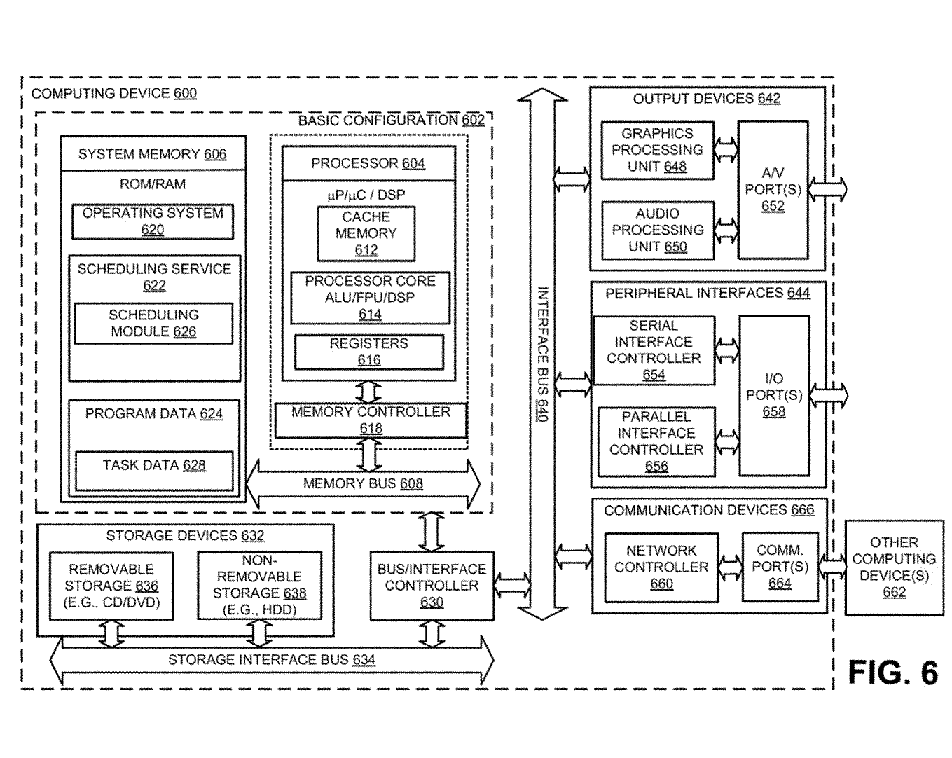

FIG. 6 is a block diagram of an example computing device, which may be used to provide a workflow management with location, temporal, and biometric information, according to embodiments.

For example, computing device 600 may be used as a server, desktop computer, portable computer, smart phone, special purpose computer, or similar device. In an example basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including but not limited to a microprocessor (μP), a microcontroller (μC), a digital signal processor (DSP), a graphics processing unit (GPU) or any combination thereof that execute operation(s) associated with a deep learning scheme, an analytics scheme, and/or an engineering application, among others. The processor 604 may include one more levels of caching, such as a level cache memory 612, one or more processor cores 614, and registers 616. The example processor cores 614 may (each) include an arithmetic logic unit (ALU), a floating point unit (FPU), a digital signal processing core (DSP Core), or any combination thereof. An example memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a scheduling service 622, and a program data 624. The scheduling service 622 may include a component such as a scheduling module 626. The scheduling module 626 may execute the processes associated with the scheduling service 622. The scheduling module 626 may receive a start task signal from a client device of an employee at a start time-period associated with a task. The start signal may include a biometric identifier associated with the employee, a location of the client device, and a task identifier of the task. Next, the task may be identified within a schedule using the task identifier. The schedule may be composed by a manager of the employee. The biometric identifier may be verified as matching the employee. The location of the client device may be confirmed as within a geo-fenced area designated to the task. A status of the task may be recorded as started within the schedule.

Input to and output out of the scheduling service 622 may be transmitted through a communication module associated with the computing device 600. An example of the communication module may include a communication device 666 that may be communicatively coupled to the computing device 600. The communication module may provide wired and/or wireless communication. The program data 624 may also include, among other data, task data 628, or the like, as described herein. The task data 628 may include biometric identifier, task identifier, location information, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDDs), optical disk drives such as compact disk (CD) drives or digital versatile disk (DVD) drives, solid state drives (SSDs), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636 and the non-removable storage devices 638 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 include a graphics processing unit 648 and an audio processing unit 650, which may be configured to communicate to various external devices such as a display or speakers via one or more A/V ports 652. One or more example peripheral interfaces 644 may include a serial interface controller 654 or a parallel interface controller 656, which may be configured to communicate with external devices such as input devices (for example, keyboard, mouse, pen, voice input device, touch input device, etc. or other peripheral devices (for example, printer, scanner, etc.) via one or more I/O ports 658. An example of the communication device(s) 666 includes a network controller 660, which may be arranged to facilitate communications with one or more other computing devices 662 over a network communication link via one or more communication ports 664. The one or more other computing devices 662 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations. Additionally, the computing device 600 may include specialized hardware such as an application-specific integrated circuit (ASIC), a field programmable gate array (FPGA), a programmable logic device (PLD), and/or a free form logic on an integrated circuit (IC), among others.

Example embodiments may also include methods to provide a workflow management with location, temporal, and biometric information. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

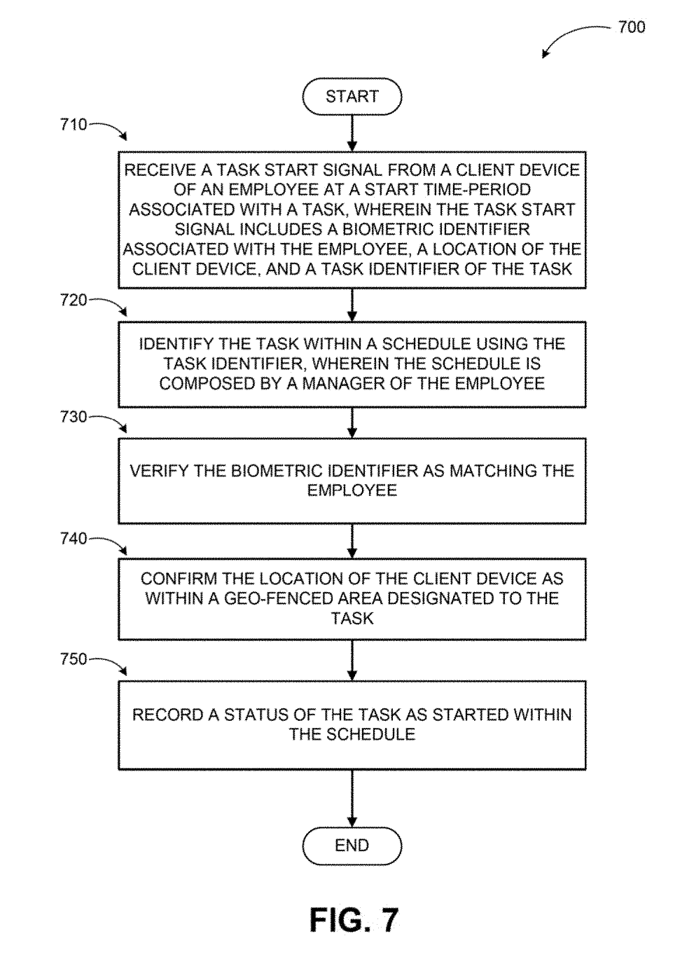

FIG. 7 is a logic flow diagram illustrating a process for providing a workflow management with location, temporal, and biometric information, according to embodiments. Process 700 may be implemented on a computing device, such as the computing device 600 or another system.

Process 700 begins with operation 710, where the scheduling service may receive a start task signal from a client device of an employee at a start time-period associated with a task. The start signal may include a biometric identifier associated with the employee, a location of the client device, and a task identifier of the task. At operation 720, the scheduling service may identify the task within a schedule using the task identifier. The schedule may be composed by a manager of the employee.

At operation 730, the scheduling service may verify the biometric identifier as matching the employee. The biometric identifier may be compared to a biometric information of the employee from a profile of the employee. At operation 740, the location of the client device may also be confirmed as within a geo-fenced area designated to the task. The geo-fenced area may be defined by the manager as a property of the task or may be automatically inferred based on attribute(s) of the task. At operation 750, upon verification of information within the start task signal, a status of the task may be recorded as started within the schedule.

The operations included in process 700 is for illustration purposes. Providing a workflow management with location, temporal, and biometric information may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a method executed on a computing device to provide a workflow management based on location, temporal, and biometric information is described. The method includes receiving a start task signal from a client device of an employee at a start time-period associated with a task, where the start task signal includes a biometric identifier associated with the employee, a location of the client device, and a task identifier of the task, identifying the task within a schedule using the task identifier, where the schedule is composed by a manager of the employee, verifying the biometric identifier as matching the employee, confirming the location of the client device as within a geo-fenced area designated to the task, and recording a status of the task as started within the schedule.

In other examples, the method further includes detecting the task identifier as a quick response (QR) code that is assigned to the task and verifying a scanner of the QR code as the client device of the employee. The method further includes verifying a scanner of the biometric identifier as the client device of the employee. The method further includes comparing a scan time associated with the biometric identifier to the start time-period associated with the task, in response to detecting the scan time as before, the start time-period, notifying the manager of the status of the task as started early, and in response to detecting the scan time as after the start time-period, notifying the manager of the status of the task as started late. Verifying the biometric identifier as matching the employee includes accessing a biometric information of the employee from a profile associated with the employee and matching the biometric identifier to the biometric information of the employee.

In further examples, the method further includes receiving an end task signal from the client device of the employee at an end time-period associated with the task, where the end task signal includes the biometric identifier associated with the employee, the location of the client device, and the task identifier of the task, verifying the biometric identifier as matching the employee, confirming the location of the client device as within the goo-fenced area assigned to the task, and recording the status of the task as completed. Recording the status of the task as completed includes verifying a scanner of the task identifier as the client device of the employee and matching a scan time of the task identifier to the end time-period associated with the task. The method further includes verifying a scanner of the biometric identifier as the client device of the employee and matching a scan time of the biometric identifier to the end time-period associated with the task.

In other examples, the method further includes receiving a request from the employee to switch the task with other employee. The method further includes transmitting the request to switch the task to the manager, receiving an approval reply from the manager, re-assigning the task to the other employee on the schedule, and notifying the employee and the other employee of the re-assigned task. The method further includes inferring an ability and an availability of the other employee to complete the task, automatically re-assigning the task to the other employee on the schedule, and notifying the manager, the employee, and the other employee of the re-assigned task.

In some examples, a server configured to provide workflow management based on location, temporal, and biometric information. The server includes a communication module configured to facilitate communication between a scheduling service and a client device that captures the location, temporal, and biometric information, a memory configured to store instructions, and a processor coupled to the memory and the communication module. The processor executes the scheduling service in conjunction with the instructions stored in the memory. The scheduling service includes a schedule module. The scheduling module is configured to transmit a schedule generated by a manager and a first confirmation request to an employee, receive a first confirmation notification that includes a biometric identifier associated with the employee, detect an update to the schedule provided by the manager, transmit the update to the employee and a second confirmation request to the employee, and receive a second confirmation notification and the biometric identifier associated with the employee.

In other examples, the scheduling module is further configured to match the biometric identifier to the employee, verify a scanner of the biometric identifier associated with the first confirmation notification as the client device of the employee, and change a status of a task within the schedule as confirmed by the employee. The scheduling module is further configured to match the biometric identifier to the employee, verify a scanner of the biometric identifier associated with the second confirmation notification as the client device of the employee, apply the update to a task within the schedule, and/or change a status of a new task within the schedule as confirmed by the employee.

In further examples, the scheduling module is further configured to receive a location of the client device from the client device of the employee at a start time-period of a task assigned to the employee within the schedule, identify the location of the client device as within a geo-fenced area associated with the task, and instruct the client device to enable or suppress a notification received during a time-period of the task based on a work rule associated with the task. The scheduling module is further configured to receive a location of the client device from the client device of the employee at an end time-period of a task assigned to the employee within the schedule and transmit a reminder to the employee to complete an end-task activity, where the end-task activity includes a transition action, a clock-out action, and a report.

In other examples, the scheduling module is further configured to receive a change request to modify a task assigned to the employee and the biometric identifier from the employee, validate the biometric identifier as matching the employee and as scanned with the client device of the employee, and analyze the change request for a compliance with a labor regulation. The scheduling module is further configured to verify the change request as in compliance with the labor regulation, modify the task within the schedule based on the change request, and notify the employee and the manager of the modified task within the schedule.

In some examples, a method executed on a computing device to provide workflow management based on location, temporal, and biometric information is described. The method may include actions that are similar to actions provided by the scheduling module of the server.

In other examples, the method may further include receiving a change request to modify a task assigned to the employee and the biometric identifier from the employee, validating the biometric identifier as matching the employee and as scanned with a client device of the employee, analyzing the change request for a compliance with a labor regulation, detecting the change request as failing to comply with the labor regulation, rejecting the change request, and notifying the employee and the manager of a rejection of the change request.

In some examples, a means for providing workflow management based on location, temporal, and biometric information is described. The means for providing workflow management based on location, temporal, and biometric information includes a means for receiving a start task signal from a client device of an employee at a start time-period associated with a task, where the start task signal includes a biometric identifier associated with the employee, a location of the client device, and a task identifier of the task, a means for identifying the task within a schedule using the task identifier, where the schedule is composed by a manager of the employee, a means for verifying the biometric identifier as matching the employee, a means for confirming the location of the client device as within a geo-fenced area designated to the task, and a means for recording a status of the task as started within the schedule.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device to provide a workflow management based on location, temporal, and biometric information, the method comprising:
receiving a start task signal from a client device of an employee at a start time-period associated with a task, wherein the start task signal includes a biometric identifier associated with the employee, a location of the client device, and a task identifier of the task;
identifying the task within a schedule using the task identifier, wherein the schedule is composed by a manager of the employee;
verifying the biometric identifier as matching the employee;
confirming the location of the client device as within a geo-fenced area designated to the task; and
recording a status of the task as started within the schedule.

2. The method of claim 1, further comprising:
detecting the task identifier as a quick response (QR) code that is assigned to the task; and
verifying a scanner of the QR code as the client device of the employee.

3. The method of claim 1, further comprising:
verifying a scanner of the biometric identifier as the client device of the employee.

4. The method of claim 1, further comprising:
comparing a scan time associated with the biometric identifier to the start time-period associated with the task;
in response to detecting the scan time as before the start time-period, notifying the manager of the status of the task as started early; and
in response to detecting the scan time as after the start time-period, notifying the manager of the status of the task as started late.

5. The method of claim 1, wherein verifying the biometric identifier as matching the employee comprises:
accessing a biometric information of the employee from a profile associated with the employee; and
matching the biometric identifier to the biometric information of the employee.

6. The method of claim 1, further comprising:
receiving an end task signal from the client device of the employee at an end time-period associated with the task, wherein the end task signal includes the biometric identifier associated with the employee, the location of the client device, and the task identifier of the task;
verifying the biometric identifier as matching the employee;
confirming the location of the client device as within the geo-fenced area assigned to the task; and
recording the status of the task as completed.

7. The method of claim 6, wherein recording the status of the task as completed comprises:
verifying a scanner of the task identifier as the client device of the employee; and
matching a scan time of the task identifier to the end time-period associated with the task.

8. The method of claim 6, further comprising:
verifying a scanner of the biometric identifier as the client device of the employee; and
matching a scan time of the biometric identifier to the end time-period associated with the task.

9. The method of claim 1, further comprising:
receiving a request from the employee to switch the task with other employee.

10. The method of claim 9, further comprising:
transmitting the request to switch the task to the manager;
receiving an approval reply from the manager;
re-assigning the task to the other employee on the schedule; and
notifying the employee and the other employee of the re-assigned task.

11. The method of claim 9, further comprising:
inferring an ability and an availability of the other employee to complete the task;
automatically re-assigning the task to the other employee on the schedule; and
notifying the manager, the employee, and the other employee of the re-assigned task.

12. A server configured to provide workflow management based on location, temporal, and biometric information, the server comprising:
a communication module configured to facilitate communication between a scheduling service and a client device that captures the location, temporal, and biometric information;
a memory configured to store instructions; and
a processor coupled to the memory and the communication module, the processor executing the scheduling service in conjunction with the instructions stored in the memory, wherein the scheduling service includes:
a scheduling module configured to:
transmit a schedule generated by a manager and a first confirmation request to an employee;
receive a first confirmation notification that includes a biometric identifier associated with the employee;
detect an update to the schedule provided by the manager;
transmit the update to the employee and a second confirmation request to the employee; and
receive a second confirmation notification and the biometric identifier associated with the employee.

13. The server of claim 12, wherein the scheduling module is further configured to:
match the biometric identifier to the employee;
verify a scanner of the biometric identifier associated with the first confirmation notification as the client device of the employee; and
change a status of a task within the schedule as confirmed by the employee.

14. The server of claim 12, wherein the scheduling module is further configured to:
match the biometric identifier to the employee;
verify a scanner of the biometric identifier associated with the second confirmation notification as the client device of the employee;
one or more of:
apply the update to a task within the schedule; and
change a status of a new task within the schedule as confirmed by the employee.

15. The server of claim 12, wherein the scheduling module is further configured to:
receive a location of the client device from the client device of the employee at a start time-period of a task assigned to the employee within the schedule;
identify the location of the client device as within a geo-fenced area associated with the task; and
instruct the client device to enable or suppress a notification received during a time-period of the task based on a work rule associated with the task.

16. The server of claim 12, wherein the scheduling module is further configured to:
receive a location of the client device from the client device of the employee at an end time-period of a task assigned to the employee within the schedule; and
transmit a reminder to the employee to complete an end-task activity, wherein the end-task activity includes a transition action, a clock-out action, and a report.

17. The server of claim 12, wherein the scheduling module is further configured to:
receive a change request to modify a task assigned to the employee and the biometric identifier from the employee;
validate the biometric identifier as matching the employee and as scanned with the client device of the employee; and
analyze the change request for a compliance with a labor regulation.

18. The server of claim 17, wherein the scheduling module is further configured to:
verify the change request as in compliance with the labor regulation;
modify the task within the schedule based on the change request; and
notify the employee and the manager of the modified task within the schedule.

19. A method executed on a computing device to provide workflow management based on location, temporal, and biometric information, the method comprising:
transmitting a schedule generated by a manager and a first confirmation request to an employee;
receiving a first confirmation notification that includes a biometric identifier associated with the employee;
detecting an update to the schedule provided by the manager;
transmitting the update to the employee and a second confirmation request to the employee; and
receiving a second confirmation notification and the biometric identifier associated with the employee.

20. The method of claim 19, further comprising:
receiving a change request to modify a task assigned to the employee and the biometric identifier from the employee;
validating the biometric identifier as matching the employee and as scanned with a client device of the employee;
analyzing the change request for a compliance with a labor regulation;
detecting the change request as failing to comply with the labor regulation;
rejecting the change request; and
notifying the employee and the manager of a rejection of the change request.
